(19) United States
(12) Patent Application Publication
(10) Pub. No.: US 2005/0159172 A1
(43) Pub. Date: Jul. 21, 2005

(54) System and method for locating a mobile telephone handset using a web browser

(76) Inventor: Ram M. Shamanna, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/757,437

(22) Filed: Jan. 15, 2004

(51) Int. Cl. H04Q 7/20

(52) U.S. Cl. 455/456.2; 455/457; 455/414.2

(57) ABSTRACT

A system and corresponding method provide a web-based location finder service that enables a user to locate a subscriber's mobile telephone handset using a web browser. The web-based location finder service uses a position determination system to determine the location of a mobile telephone handset. A user with permission may use a web browser on a computer, such as a personal computer (PC) or a handheld computer, to log on to the web-based location finder service and conveniently track the location of a mobile telephone handset.

### TECHNICAL FIELD

The technical field relates to computer network systems, and, in particular, to a web-based location finder service.

### BACKGROUND

Wireless communications systems are becoming increasingly important and popular worldwide. Major cellular telephone carriers are offering cost efficient wireless plans, including family plans. Most people now use cellular telephones as their primary communications tools. Consequently, an easy way to locate a family member or a friend is by dialing their cellular telephone number and talking to them. However, making telephone conversation may be distracting, for example, when the person to be located is attending a meeting or watching a movie. Talking on the telephone may even be dangerous when the person is driving. In addition, calling may not be desired if, for example, a parent merely wants to know whether his or her child is indeed studying at a friend's house or partying at a club. The parent may not even want the child to know that he is being monitored.

### SUMMARY

A method for locating a mobile telephone handset using a web browser includes providing an interface for a user to log on to a location finder service and enter a telephone number of a mobile handset to be tracked. The user logs on to the location finder service using a web browser on a computer. The method further includes authenticating the user and the telephone number, passing the telephone number to a position determination system, determining a location of the mobile handset associated with the telephone number, and displaying the location of the mobile handset on a display device of the computer.

A corresponding system for locating a mobile telephone handset using a web browser includes an interface that enables a user to log on to a location finder service and enter a telephone number of a mobile handset to be tracked. The user logs on to the location finder service using a web browser on a computer. The system further includes a position determination system operably connected to the interface. The position determination system interacts with a mobile switching center to determine a location of the mobile handset associated with the telephone number. A map of the location of the mobile handset may be displayed on a display device on the computer.

### DESCRIPTION OF THE DRAWINGS

Embodiments of the system and method for locating a mobile telephone handset using a web browser will be described in detail with reference to the following figures, in which like numerals refer to like elements, and wherein:

FIG. 1 illustrates an exemplary system for locating a mobile telephone handset using a web browser, in accordance with an embodiment;

FIG. 2 illustrates exemplary hardware components of a computer that may be used in connection with the exemplary system of FIG. 1, in accordance with an embodiment;

FIG. 3 is a flow chart illustrating an exemplary method for locating a mobile telephone handset using a web browser, in accordance with an embodiment; and

FIG. 4 is a flow chart illustrating an exemplary operation of a position determination system used in connection with the exemplary system of FIG. 1 and the exemplary method of FIG. 2, in accordance with an embodiment.

### DETAILED DESCRIPTION

A system and corresponding method provide a web-based location finder service that enables a user to locate a subscriber's mobile telephone handset using a web browser. The web-based location finder service uses a position determination system to determine the location of a mobile telephone handset. A user with permission may use a web browser on a computer, such as a personal computer (PC), a handheld computer, etc, to log on to the web-based location finder service and conveniently track the location of a mobile telephone handset.

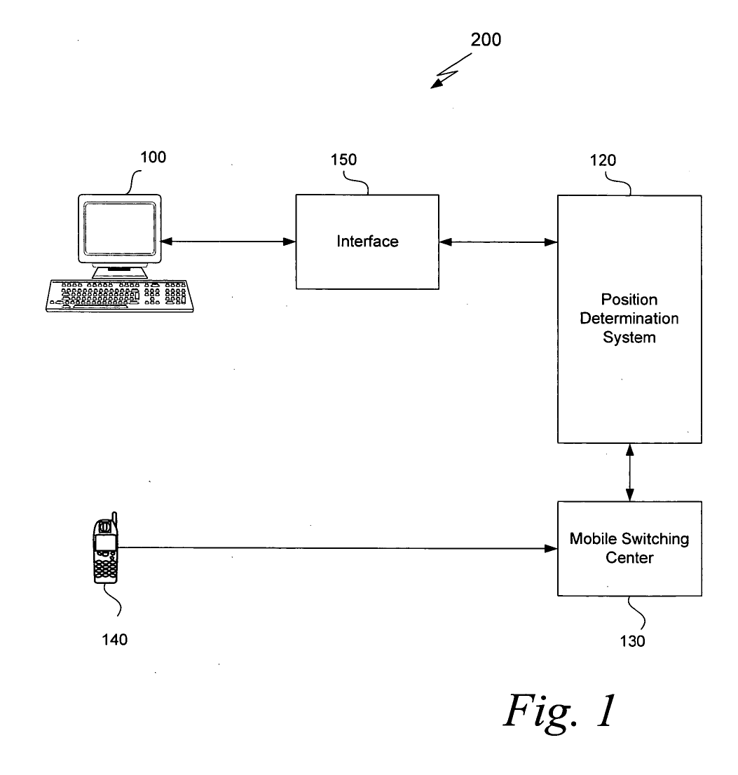

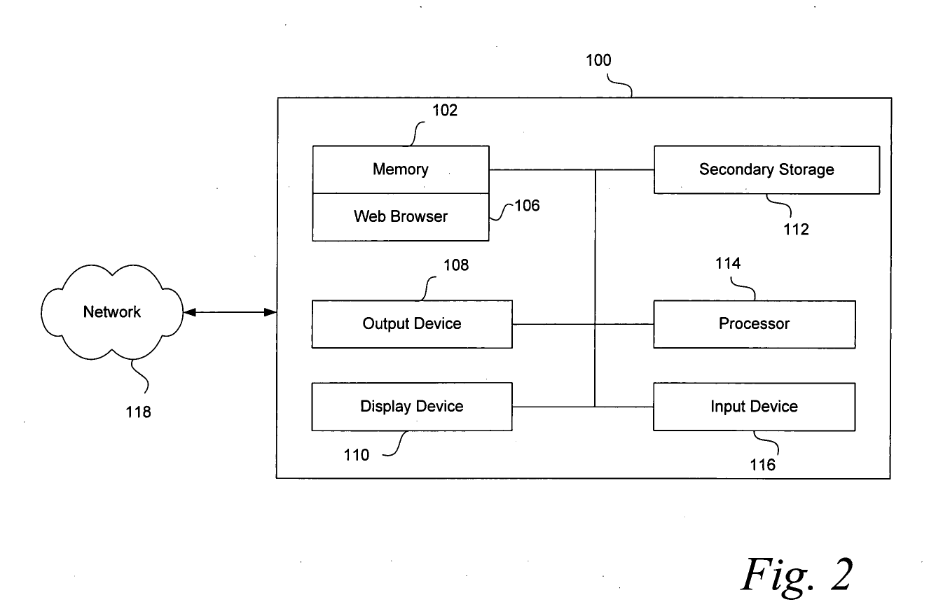

FIG. 1 illustrates an exemplary system 200 for locating a mobile telephone handset using a web browser (shown in FIG. 2). A user may use a computer 100 and a world wide web (WWW) interface 150 to sign on and log on to the web-based location finder service. In the embodiment of FIG. 1, the interface 150 may be any user interface capable of accepting a string of digits as input and displaying a geographical map as output. The interface 150 may also be a Java® servlet for building interactive web applications. The interface 150 authenticates the user, accepts the telephone number to be tracked, and passes on the information to a position determination system 120. The position determination system 120 interacts with a mobile switching center 130 and determines a location of the handset 140 associated with the telephone number. A mobile switching center makes radio contact with the mobile station that is being tracked. The mobile switching center coordinates the setting up of calls to and from wireless telephone users. In an embodiment, the mobile switching center 130 is a switch and has access to several databases to assist in the task of setting up calls. The location information is transmitted back to the interface 150, which displays a map of the approximate location of the handset 140 on a display device (shown in FIG. 2) on the computer 100.

FIG. 2 illustrates exemplary hardware components of a computer 100 that may be used in connection with the method for locating a mobile telephone handset 140 using a web browser 106. The computer 100 includes a connection with a network 118 such as the Internet or other type of computer or telephone network. The position determination system 120 (shown in FIG. 1) may be connected to the computer 100 through the network 118. The computer 100 typically includes a memory 102, a secondary storage device 112, a processor 114, an input device 116, a display device 110, and an output device 108.

The memory 102 may include random access memory (RAM) or similar types of memory. The web browser 106 makes a connection to the network 118 and receives information, such as the location of the handset 140, from the network 118 to be displayed on the computer 100. The secondary storage device 112 may include a hard disk drive, floppy disk drive, CD-ROM drive, or other types of non-volatile data storage, and may correspond with various databases or other resources. The processor 114 may execute information stored in the memory 102, the secondary storage 112, or received from the Internet or other network 118. The input device 116 may include any device for entering data into the computer 100, such as a keyboard, keypad, cursor-control device, touch-screen (possibly with a stylus), or microphone. The display device 110 may include any type of device for presenting visual image, such as, for example, a computer monitor, flat-screen display, display panel, etc. The output device 108 may include any type of device for presenting data in hard copy format, such as a printer, and other types of output devices including speakers, devices for providing data in audio form, etc. The computer 100 can include multiple input devices, output devices, and display devices.

Although the computer 100 is depicted with various components, one skilled in the art will appreciate that the computer 100 can contain additional or different components. In addition, although aspects of an implementation consistent with the method for locating a mobile telephone handset 140 using a web browser are described as being stored in memory, one skilled in the art will appreciate that these aspects of the implementation can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 100 to perform a particular method.

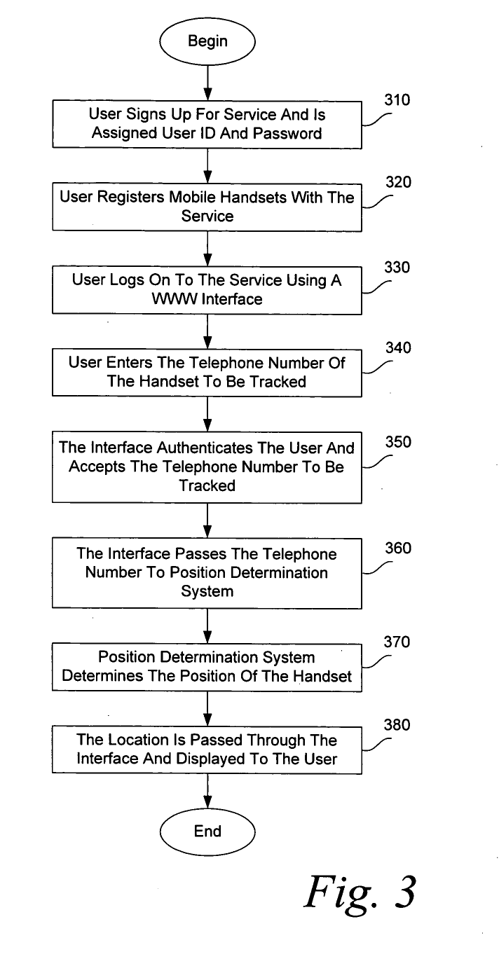

FIG. 3 is a flow chart illustrating an exemplary method for locating a mobile telephone handset 140 using a web browser 106. A user first signs up for the web-based location finder service, which interacts with one or more telephone carriers' web sites (block 310). Upon signing up, the user is provided with a username and password for unique identification. The user may purchase a number of mobile handsets 140 under one account through a telephone carrier. At the time of signing-up, the user may register all of the mobile handsets 140 that the user intends to track (block 320). A user may be allowed to track only those handsets 140 that are part of the same account. Alternatively, access may be granted to a user who is willing to pay a fee. The fee may be a flat monthly fee or a pay-per-use fee.

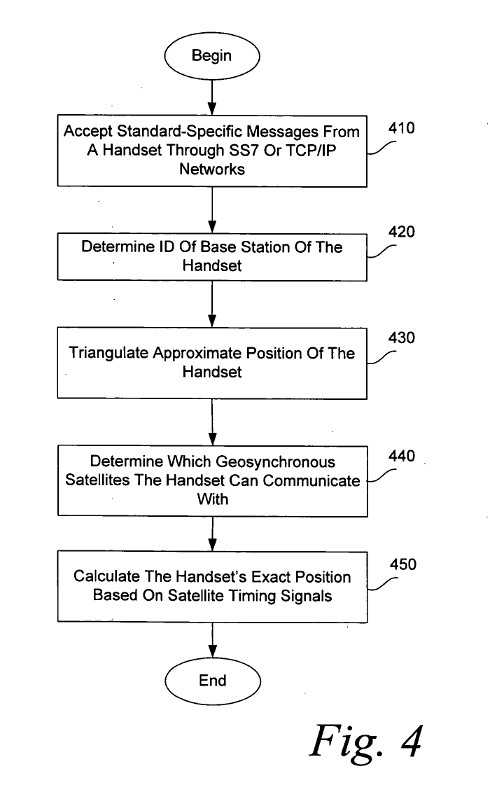

When the user wishes to locate one of the mobile handsets 140 registered with the service, the user may use the computer 100 and the interface 150 to log on to the web-based location finder service through a web site address (block 330). The web site may be the location finder service's web site the telephone carrier's web site, etc. After the user enters the mobile telephone number of the handset 140 to be tracked (block 340), the interface 150 authenticates the user through username and password verification and accepts the telephone number to be tracked (block 350). The interface 150 then passes the telephone number to be tracked to the position determination system 120 (block 360). The position determination system 120 determines the location of the handset 140 (block 370) and passes the location information to the interface 150. Block 370 will be described in detail with respect to FIG. 4. The interface 150 then displays a map of the location of the mobile handset 140 on the display 110 of the computer 100 (block 380). The user can locate a relative or friend carrying the mobile handset 140 without having to make a telephone conversation with the relative or friend.

FIG. 4 is a flow chart illustrating an exemplary operation of the position determination system 120. The position determination system 120 may be a Hewlett-Packard (HP) OpenCall position determination entity (PDE) system. The HP OpenCall PDE serves as the position determination component in a system that delivers mobile location services. Another example of the position determination system 120 may be a Compaq discovery location system that enables a carrier network to determine the physical location of a wireless customer.

Referring to FIG. 4, the position determination system 120 accepts standard-specific messages. In order to locate a mobile handset, there is an exchange of messages between the position determination system 120 and the mobile switching center 130. These messages are routed and carried from a user's handset 140 through a network 118, such as signaling system 7 (SS7) or transmission control protocol/Internet protocol (TCP/IP) networks (block 410). Every network 118 has an addressing scheme. In SS7, addresses are assigned using a three-level hierarchy. Individual signaling points are identified as belonging to a cluster of signaling points. Within that cluster, each signaling point is assigned a member number. Similarly, a cluster is defined as being part of a network 118. Any node in the American SS7 network can be addressed by a three-level number defined by its network, cluster, and member numbers. Each of these numbers is an 8-bit number and can assume values from 0 to 255. This three-level address is known as a point code of the signaling point. A point code uniquely identifies a signaling point within the America region.

In block 420, the position determination system 120 interacts with the mobile switching center 130 and determines the identities of base stations that the caller's handset 140 is capable of contacting. As part of locating a mobile handset 140, the position determination system 120 exchanges some messages with the mobile handset 140. The position determination system 120 communicates with the mobile handset 140 through the mobile switching center 130, because the mobile switching center 130 (with its associated databases) has the information about where the mobile handset 140 is. The mobile handset 140 first makes radio contact with the base stations. As part of their communication, the mobile handset 140 and the base stations exchange the identities of base stations. A cellular carrier typically divides its service areas into multiple markets with unique identifications (ID). For example, Washington, D.C. is one market with Verizon. Each market may have one or more base stations (each having a unique ID) that are served by one or more mobile switching center 130 (each having a unique ID). A base station ID may be a number that is a combination of the market ID, the mobile switching center ID, and the base station ID.

The position determination system 120 then triangulates the approximate position of the handset 140 (block 430). The position determination system 120 can triangulate the position of the mobile handset 140 after getting the standard-specific network messages (block 410) and ascertaining which base station is serving the mobile handset 140 (block 420). Triangulation is a process by which the location of a radio transmitter can be determined by measuring either the radial distance or the direction of a received signal from two or three different points. Triangulation is well known in the art and is typically used in cellular communications to pinpoint the geographic position of a user's handset, such as handset 140.

After the approximate position of the handset 140 is determined, the position determination system 120 then determines which geosynchronous satellites the handset 140 can communicate with (block 440). If the handset 140 is global positioning system (GPS)-enabled, the handset's exact position can be calculated (block 450). GPS provides specially coded satellite (SV) timing signals that can be processed in a GPS receiver, enabling the receiver to accurately compute position, velocity and time. GPS systems are well known in the art. The position determination system 120 requests the SV timing signals from the GPS-enabled handset 140 in order to locate the handset 140. The handset's location is typically updated every time the handset 140 receives SV timing signals from a satellite, such as when making or receiving a call.

The position determination processes and associated tools and utilities may be installed as a single call processing application on a network node connected to the network 118, such as an OpenCall intelligent network server (INS) node.

The system 200 may be used in connection with mobile telephone carriers, such as code-division multiple access (CDMA) carriers. CDMA carriers use spread-spectrum techniques and do not assign a specific frequency to each user. Instead, every channel uses the full available spectrum. Individual conversations are encoded with a pseudo-random digital sequence.

While the system and method for locating a mobile telephone handset using a web browser have been described in connection with an exemplary embodiment, those skilled in the art will understand that many modifications in light of these teachings are possible, and this application is intended to cover variations thereof.

1. A method for locating a mobile telephone handset using a web browser, the method comprising:
providing an interface for a user to log on to a location finder service and enter a telephone number of a mobile handset to be tracked, wherein the user logs on to the location finder service using a web browser on a computer;
authenticating the user and the telephone number;
passing the telephone number to a position determination system;
determining a location of the mobile handset associated with the telephone number; and
displaying the location of the mobile handset on a display device of the computer.

2. The method of claim 1, wherein the determining step further comprises accepting messages from the mobile handset through signaling system 7 (SS7) networks.

3. The method of claim 1, wherein the determining step further comprises determining a base station identification of the mobile handset.

4. The method of claim 1, wherein the determining step further comprises triangulating an approximate position of the mobile handset.

5. The method of claim 1, wherein the determining step further comprises determining geosynchronous satellites with which the mobile handset communicates.

6. The method of claim 1, wherein the determining step further comprises calculating a position of a global positioning system (GPS)-enabled mobile handset based on satellite timing signals.

7. The method of claim 1, further comprising enabling the user to register one or more mobile handset with the location finder service.

8. The method of claim 1, further comprising enabling the user to track a mobile handset by paying a fee.

9. A system for locating a mobile telephone handset using a web browser, comprising:
an interface that enables a user to log on to a location finder service and enter a telephone number of a mobile handset to be tracked, the user logging on to the location finder service using a web browser on a computer;
a position determination system operably connected to the interface, the position determination system interacting with a mobile switching center to determine a location of the mobile handset associated with the telephone number;
a display device that displays the location of the mobile handset on the computer.

10. The system of claim 9, wherein the interface is a world wide web (WWW) interface.

11. The system of claim 9, wherein the position determination system accepts messages from the mobile handset through signaling system 7 (SS7) networks.

12. The system of claim 9, wherein the position determination system accepts messages from the mobile handset through transmission control protocol/Internet protocol (TCP/IP) networks.

13. The system of claim 9, wherein the position determination system determines a base station identification of the mobile handset.

14. The system of claim 9, wherein the position determination system triangulates an approximate position of the mobile handset.

15. The system of claim 9, wherein the position determination system determines geosynchronous satellites with which the mobile handset communicates.

16. The system of claim 9, wherein the display device displays a map of the location of the mobile handset on the computer.

17. The system of claim 9, wherein the interface authenticates the user and the telephone number through username and password verification.

18. The system of claim 9, wherein the mobile handset is global positioning system (GPS)-enabled.

19. The system of claim 9, wherein the mobile handset is registered with a code-division multiple access (CDMA) carrier.

20. A computer readable medium providing instructions for locating a mobile telephone handset using a web browser, the instructions comprising:
providing an interface for a user to log on to a location finder service and enter a telephone number of a mobile handset to be tracked, wherein the user logs on to the location finder service using a web browser on a computer;
authenticating the user and the telephone number;
passing the telephone number to a position determination system;
determining a location of the mobile handset associated with the telephone number; and
displaying the location of the mobile handset on a display device of the computer.
